(19) United States
(12) Patent Application Publication
(10) Pub. No.: US 2017/0280850 A1
(43) Pub. Date: Oct. 5, 2017

(54) COMPACT CONTAINER HAVING OPAQUE THIN FILM INSERT-MOLDED ONTO BOTTOM SURFACE OF TRANSPARENT DISCHARGE PLATE

(71) Applicant: PUM-TECH KOREA CO., LTD, Incheon (KR)

(72) Inventor: Do Hoon LEE, Bucheon-si (KR)

(21) Appl. No.: 15/485,076

(22) Filed: Apr. 11, 2017

(30) Foreign Application Priority Data
Mar. 31, 2016 (KR) 10-2016-39043

(51) Int. Cl. A45D 33/02; A45D 33/00; A45D 33/18; A45D 40/22

(52) U.S. Cl. CPC A45D 33/025; A45D 40/222; A45D 33/008; A45D 33/003; A45D 33/18; A45D 2040/223

(57) ABSTRACT

Provided is a compact container having an opaque thin film insert-molded onto a bottom surface of a transparent discharge plate. The compact container includes: an outer container (10); an outer container lid (20) hinged to one side of the outer container (10) so as to be opened and closed; a container body (30) mounted inside the outer container (10); a discharge device (40) for discharging a cosmetic product; and a discharge plate (60) disposed adjacent to the discharge device (40) and formed therein with a plurality of discharge openings (62), wherein the discharge plate (60) is formed of a transparent synthetic resin material, and an opaque thin film (64) is insert-molded onto a bottom surface of the discharge plate (60).

### CROSS-REFERENCE TO RELATED APPLICATION

This application claims the benefit of Korean application No. 10-2016-39043, filed on Mar. 31, 2016 with the Korean Intellectual Property Office, the disclosure of which is incorporated herein by reference.

### BACKGROUND OF THE INVENTION

### 1. Field of the Invention

The present invention relates to a compact container having an opaque thin film insert-molded onto a bottom surface of a transparent discharge plate, and more specifically, to a compact container having an opaque thin film insert-molded onto a bottom surface of a transparent discharge plate, in which a discharge device for discharging a cosmetic product is mounted inside the compact container, the discharge plate having a plurality of discharge openings is provided on a top of the discharge device, the discharge plate is formed of a transparent material, and the opaque thin film formed of a metal material such as an aluminum foil is insert-molded onto the bottom surface of the discharge plate. Accordingly, the discharge plate may give a metallic impression even when the metal material is not exposed to a top of the discharge plate, so that a metal portion of the discharge plate may be prevented from being scratched and discolored by fine grains of the cosmetic product discharged to a top surface of the discharge plate, or producing a unique odor of metal. In addition, the present invention relates to a compact container having an opaque thin film insert-molded onto a bottom surface of a transparent discharge plate, in which the opaque thin film formed of opaque cellophane paper having various colors or designs is insert-molded onto the bottom surface of the transparent discharge plate, so that colors or designs of the discharge plate may be variously changed depending on the colors of the cellophane paper.

### 2. Description of the Related Art

In general, women perform makeup by using cosmetic products to make their faces look bright and beautiful.

The cosmetic products are classified into basic cosmetics, makeup cosmetics, functional cosmetics, hair cosmetics and the like according to a function of the cosmetic products. In addition, the cosmetic products are classified into powder, liquid, gel, and solid cosmetic products according to a state of the cosmetic products, and stored in a container suitable for each state of the cosmetic products.

The makeup cosmetics are classified into a base makeup used for uniformly toning the skin and covering a defect on the skin and a point makeup for partially increasing a three-dimensional effect on lips, eyes, nails and the like, in which the base makeup includes a makeup base, a foundation, a powder and the like, and the point makeup includes a lipstick, an eyeliner, a mascara and the like.

Among the makeup cosmetics, the foundation included in the base makeup is classified into a solid foundation, a liquid foundation and a gel foundation according to a type of cosmetic contents. Although the solid foundation produces an effect of excellently covering the skin, the solid foundation may be conglomerated when correcting the makeup, so that the number of users favoring the gel foundation that gives a good close contact feel is increasing.

The gel foundation is prepared by mixing a color power material with components such as a binder or an emulsifier, melting the mixture at a predetermined temperature, and cooling the melted mixture. Then, the gel foundation is usually contained in a compact container, and when makeup is performed, the gel foundation is put onto makeup tools such as a puff for facial makeup.

A conventional compact container has a structure that a gel foundation or a sponge impregnated with a gel foundation cosmetic product is exposed to the outside when a lid is opened, so that when makeup is performed, the gel foundation or the sponge impregnated with the gel foundation is directly put on the puff and applied to the skin. Thus, the cosmetic product is contaminated due to viruses, fungi, bacteria and the like existing on the skin.

In addition, the gel foundation is put on the puff more than necessary according to the pressure which is applied by the user with the puff to the gel foundation or the sponge impregnated with the gel foundation, so that the cosmetic product is wasted.

To solve the problems described above, Korean Patent Registration NO. 10-1471339 discloses a compact container as shown in FIG. 1, in which the compact container of the related art includes: a discharge device for discharging a cosmetic product to the outside; and a discharge plate provided at one side of the discharge device where the cosmetic product is discharged, having at least one discharge port, formed of a metal material, and exposed to the outside so that a puff of a user makes contact with the discharge plate and heat is dissipated to the outside.

Accordingly, the conventional compact container may have an aesthetically pleasing appearance, and may provide a refreshing feeling to the skin by lowering the temperature of the cosmetic product discharged to the discharge plate.

However, when the compact container of the related art is used for a long period of time, a top surface of the metal discharge plate is scratched, abraded, and discolored by the fine foundation powder, thereby generating a unique odor of the metal plate.

In addition, in the compact container of the related art, since the entire discharge plate is formed of a metal and a laser is used to bore a discharge hole in the discharge plate, the production cost is increased.

### SUMMARY OF THE INVENTION

To solve the problems described above, an object of the present invention is to provide a compact container having an opaque thin film insert-molded onto a bottom surface of a transparent discharge plate, in which a discharge device for discharging a cosmetic product is mounted inside the compact container, the discharge plate having a plurality of discharge openings is provided on a top of the discharge device, the discharge plate is formed of a transparent material, and the opaque thin film formed of a metal material such as an aluminum foil is insert-molded onto the bottom surface of the discharge plate. Accordingly, the discharge plate may give a metallic impression even when the metal material is not exposed to a top of the discharge plate, so that a metal portion of the discharge plate may be prevented from being scratched and discolored by fine grains of the cosmetic product discharged to a top surface of the discharge plate, or producing a unique odor of metal.

In addition, an object of the present invention is to provide a compact container having an opaque thin film insert-molded onto a bottom surface of a transparent discharge plate, in which the opaque thin film formed of a metal material is insert-molded onto the bottom surface of the transparent discharge plate formed of a synthetic resin material, so that the discharge plate may give an impression the same as a metal discharge plate while reducing the production cost.

In addition, an object of the present invention is to provide a compact container having an opaque thin film insert-molded onto a bottom surface of a transparent discharge plate, in which the opaque thin film formed of opaque cellophane paper having various colors or designs is insert-molded onto the bottom surface of the transparent discharge plate, so that colors or designs of the discharge plate may be variously changed depending on the colors of the cellophane paper.

According to the present invention, there is provided a compact container including:

an outer container (10);

an outer container lid (20) hinged to one side of the outer container (10) so as to be opened and closed;

a container body (30) mounted inside the outer container (10);

a discharge device (40) for discharging a cosmetic product;

and a discharge plate (60) adjacent to the discharge device (40),

wherein the discharge plate (60) is formed of a transparent synthetic resin material, and an opaque thin film (64) is insert-molded onto a bottom surface of the discharge plate (60).

In addition, the discharge device (40) may be a pump which includes a check valve (41), a piston (42), a piston ring (43), a sealing member (44), and an elastic member (45).

In addition, the discharge plate (60) is formed therein with a plurality of discharge openings (62), and the opaque thin film (64) is formed therein with a through hole (642) disposed at a position corresponding to the discharge opening (62).

In addition, the opaque thin film (64) is formed of a metal material.

Further, the opaque thin film (64) is an aluminum foil.

In addition, the opaque thin film (64) is opaque or translucent cellophane paper having various colors or designs.

According to the present invention, there is provided the compact container having the opaque thin film insert-molded onto the bottom surface of the transparent discharge plate, in which the discharge plate is formed of the transparent material, and the opaque thin film formed of the metal material such as the aluminum foil is insert-molded onto the bottom surface of the discharge plate. Accordingly, the discharge plate can give the metallic impression even when the metal material is not exposed to the top of the discharge plate, so that the metal portion of the discharge plate can be prevented from being scratched and discolored by the fine grains of the cosmetic product discharged to the top surface of the discharge plate, or producing the unique odor of metal.

In addition, according to the present invention, there is provided the compact container having the opaque thin film insert-molded onto the bottom surface of the transparent discharge plate, in which the opaque thin film formed of the metal material is insert-molded onto the bottom surface of the transparent discharge plate formed of the synthetic resin material, so that the discharge plate can give the impression the same as the metal discharge plate while reducing the production cost.

In addition, according to the present invention, there is provided the compact container having the opaque thin film insert-molded onto the bottom surface of the transparent discharge plate, in which the opaque thin film famed of the opaque cellophane paper having the various colors or designs is insert-molded onto the bottom surface of the transparent discharge plate, so that the colors or designs of the discharge plate can be variously changed depending on the colors of the cellophane paper.

### BRIEF DESCRIPTION OF THE DRAWINGS

FIG. 1 is a view showing a compact container having a metal discharge plate according to the related art.

FIG. 2 is a perspective view showing a compact container having an opaque thin film insert-molded onto a bottom surface of a transparent discharge plate according to the present invention.

FIG. 3 is an exploded perspective view showing the compact container having the opaque thin film insert-molded onto the bottom surface of the transparent discharge plate according to the present invention.

FIG. 4 is a sectional view showing the compact container having the opaque thin film insert-molded onto the bottom surface of the transparent discharge plate according to the present invention.

FIG. 5 is a sectional view showing a state that a cosmetic product is discharged by pressing the discharge plate of the compact container having the opaque thin film insert-molded onto the bottom surface of the transparent discharge plate according to the present invention.

FIG. 6 is a sectional view showing a state that the cosmetic product is introduced into a discharge device upon the release of pressing force applied to the compact container having the opaque thin film insert-molded onto the bottom surface of the transparent discharge plate according to the present invention.

### DETAILED DESCRIPTION OF THE INVENTION

The compact container having the opaque thin film insert-molded onto the bottom surface of the transparent discharge plate according to one embodiment of the present invention will be described with reference to accompanying drawings.

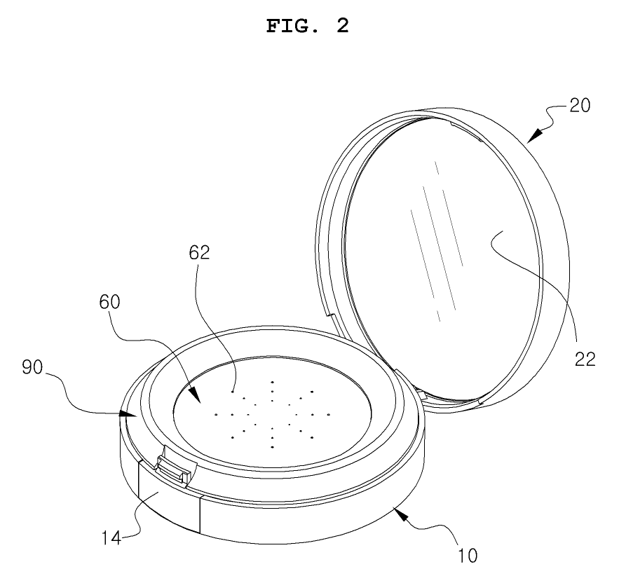

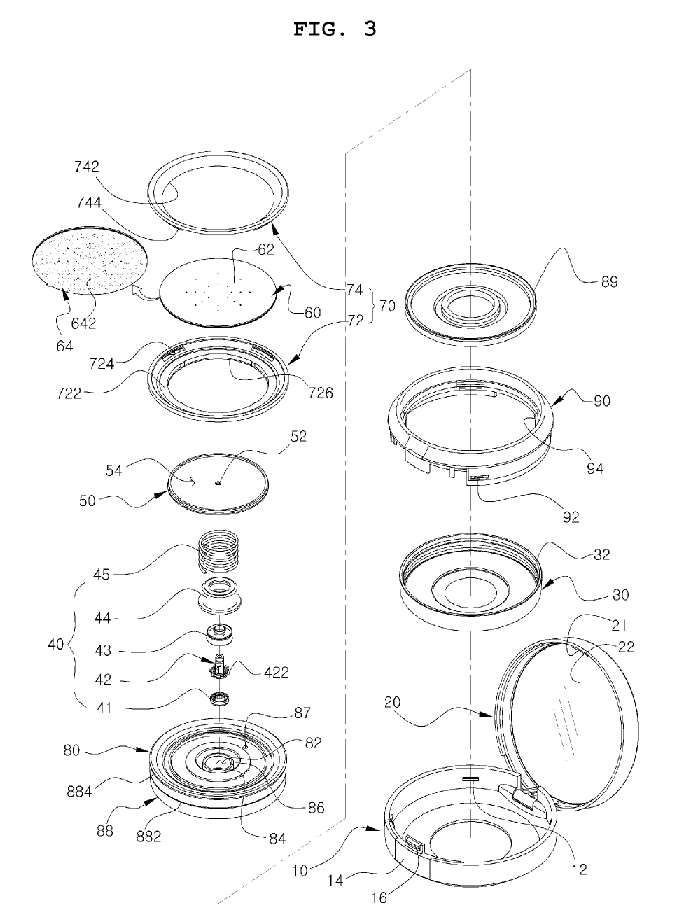

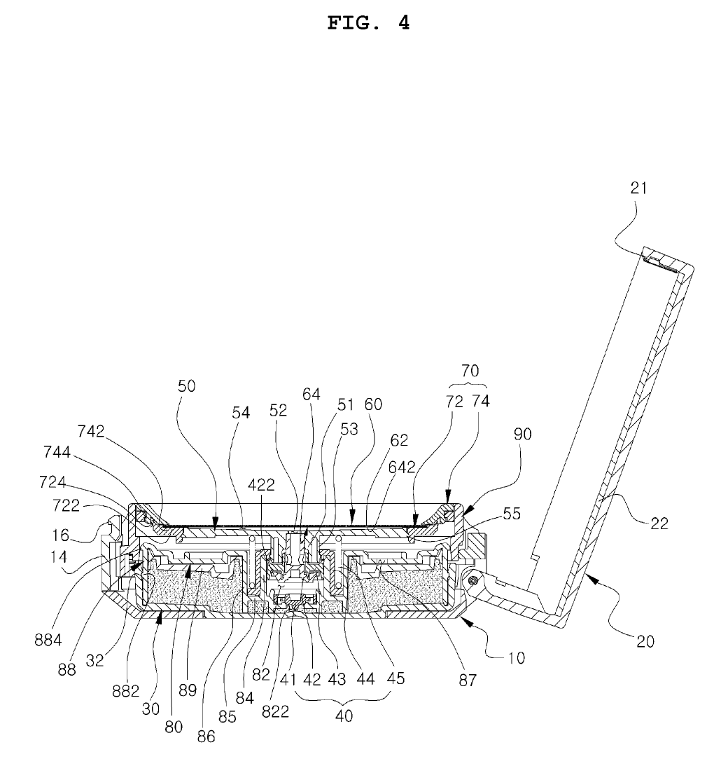

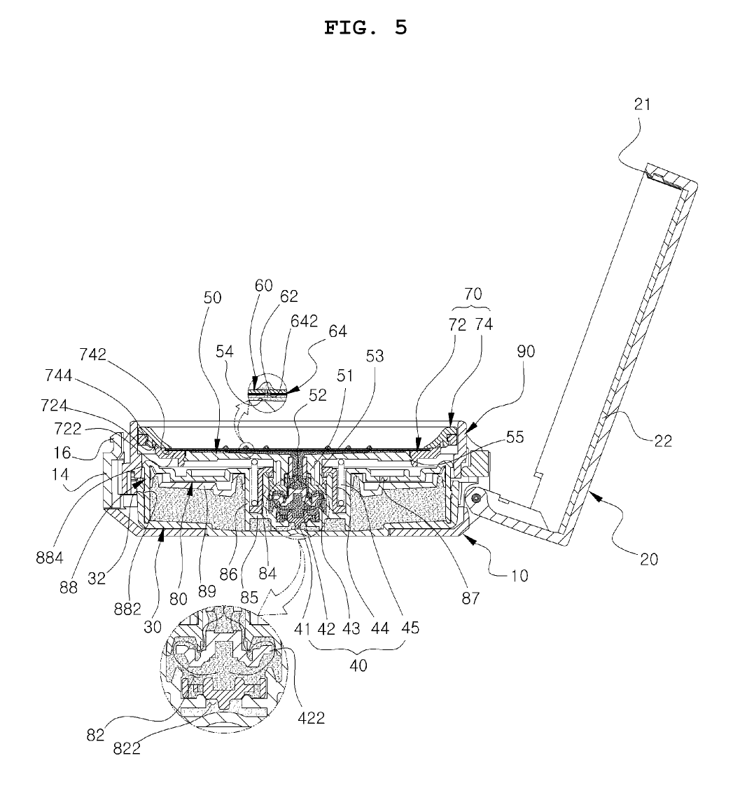

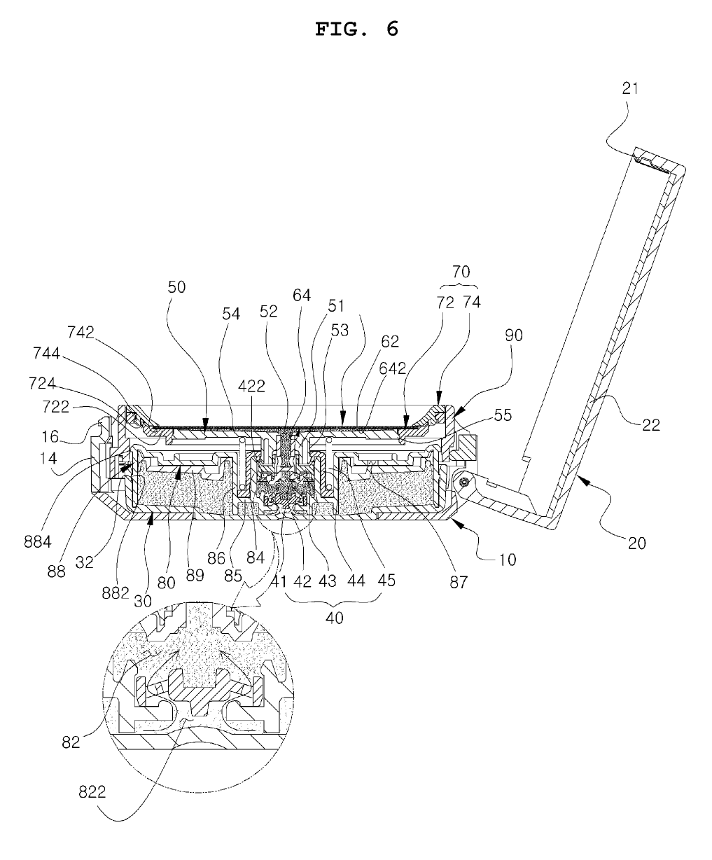

FIG. 2 is a perspective view showing a compact container having an opaque thin film insert-molded onto a bottom surface of a transparent discharge plate according to the present invention, FIG. 3 is an exploded perspective view showing the compact container having the opaque thin film insert-molded onto the bottom surface of the transparent discharge plate according to the present invention, FIG. 4 is a sectional view showing the compact container having the opaque thin film insert-molded onto the bottom surface of the transparent discharge plate according to the present invention, FIG. 5 is a sectional view showing a state that a cosmetic product is discharged by pressing the discharge plate of the compact container having the opaque thin film insert-molded onto the bottom surface of the transparent discharge plate according to the present invention, and FIG. 6 is a sectional view showing a state that the cosmetic product is introduced into a discharge device upon the release of pressing force applied to the compact container having the opaque thin film insert-molded onto the bottom surface of the transparent discharge plate according to the present invention.

According to the present invention, the compact container includes: an outer container 10; an outer container lid 20 hinged to one side of the outer container 10 so as to be opened and closed; a container body 30 mounted inside the outer container 10; a discharge device 40 for discharging a cosmetic product; and a discharge plate 60 adjacent to the discharge device 40, wherein the discharge plate 60 is formed of a transparent synthetic resin material, and an opaque thin film is insert-molded onto a bottom surface of the discharge plate 60.

The outer container 10 is mounted therein with the container body 30, and provided at an inner periphery thereof with a coupling protrusion 12 coupled to a fixing member 90.

The outer container 10 is provided at one side thereof with a button 14, and a latching protrusion 16 protrudes from an upper portion of the button 14.

The outer container lid 20 is hinged to one side of the outer container 10 to open and close the outer container 10, and a hook 21 is provided at one side of the outer container lid 20 at a position corresponding to the latching protrusion of the outer container 10 so as to be coupled to the latching protrusion 16 of the outer container 10.

In addition, a mirror 22 may be provided on an inner side of the outer container lid 20 so that a user may easily perform makeup.

The container body 30 accommodates the cosmetic product therein, and is provided at an inner periphery thereof with a mounting groove 32 coupled to a discharge device support 80.

The discharge device support 80 is coupled to an inner upper portion of the container body 30.

The discharge device support 80 is formed in a central lower side thereof with a discharge device installation hole 82, and the discharge device installation hole 82 is formed in a bottom surface thereof with a cosmetic product suction hole 822.

An inner wall 84 extends upwards from an outer side of the discharge device installation hole 82, a horizontal extension piece 85 horizontally extends outwards from the inner wall 84, and an outer wall 86 extends upwards from an outer side of the horizontal extension piece 85 while being spaced apart from the inner wall 84 by a predetermined distance.

An air flow hole 87 through which air is introduced is formed in one side of an upper surface of the discharge device support 80.

A lower extension piece 88 extends downwards from an outer side of the discharge device support 80, a mounting annular protrusion 882 protrudes from an outer periphery of the lower extension piece 88 so as to be coupled to the mounting groove of the container body 30, and a close contact annular protrusion 884 protrudes outwards from an upper side of the mounting annular protrusion 882 so as to make close contact with an inner periphery of the fixing member 90.

The discharge device support 80 is provided at an inner upper portion thereof with a push plate 89 for gathering up the cosmetic product by moving downwards as the cosmetic product accommodated inside the container body 30 is consumed.

The discharge device 40 is installed in the discharge device installation hole 82 of the discharge device support 80 to pump the cosmetic product accommodated in the container body 30.

The discharge device 40 may be a pump which includes a check valve 41 for selectively opening and closing the cosmetic product suction hole 822 of the discharge device installation hole 82, a piston 42 provided inside the discharge device installation hole 82, a piston ring 43 fitted around the piston 42 and making close contact with an inner side surface of the discharge device installation hole 82, a sealing member 44 coupled between the inner wall 84 and the outer wall 86 of the discharge device support 80, and an elastic member 45 mounted between the sealing member 44 and a dispersion distribution plate 50 to elastically support the dispersion distribution plate 50.

The dispersion distribution plate 50 is coupled to a top of the discharge device 40 so as to be movable in an up and down direction, and formed at a center thereof with a cosmetic product discharge port 52 through which the cosmetic product is discharged.

A first lower extension annular protrusion 51 extends downwards from the center of the dispersion distribution plate 50, and a second lower extension annular protrusion 53 extends downwards while being outwardly spaced apart from the first lower extension annular protrusion 51 by a predetermined distance.

An upper portion of the piston 42 of the discharge device 40 is coupled to an inside of the first lower extension annular protrusion 51, and the second lower extension annular protrusion 53 is fitted to an upper portion of the sealing member 44 of the discharge device 40 so as to be movable in the up and down direction.

A coupling annular protrusion 55 protrudes from an outer periphery of the dispersion distribution plate 50 so as to be coupled to an inside of a coupling ring 70.

The dispersion distribution plate 50 is formed at an upper portion thereof with a dispersion space 54, in which a bottom surface of the dispersion space 54 may be inclined such that the bottom surface of the dispersion space 54 smoothly rises up in the outward direction.

In other words, a central bottom surface of the dispersion space 54 is formed at a low position and the bottom surface of the dispersion space 54 gradually rises toward the outside, so that the cosmetic product discharged through the cosmetic product discharge port 52 is not firstly discharged through a discharge opening 62 positioned at a central upper portion of the dispersion space 54, and is horizontally filled up inside the dispersion space 54 while being simultaneously discharged through entire discharge openings 62 of the discharge plate 60.

Accordingly, when the user presses the discharge plate 60 to discharge the cosmetic product, the cosmetic product spreads widely over the entire dispersion space 54 while being simultaneously discharged through the discharge openings 62, so that the cosmetic product is put evenly on a puff. Accordingly, the cosmetic product is prevented from being conglomerated when the cosmetic product is applied to the skin with the puff.

The discharge plate 60 is coupled to a top of the dispersion distribution plate 50, and has a plurality of discharge openings 62 for discharging the cosmetic product pumped by the discharge device 40 to the outside. The discharge plate 60 is formed of the transparent synthetic resin material, and the opaque thin film 64 is insert-molded onto the bottom surface of the discharge plate 60.

In addition, through holes 642 are formed in the opaque thin film 64 at a position corresponding to the discharge openings 62.

The opaque thin film 64 may be famed in a circular metal plate, and particularly, the opaque thin film 64 may be an aluminum foil.

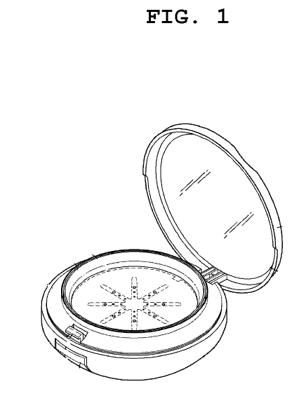

In other words, when the user discharges the cosmetic product on the top of the discharge plate and rubs the cosmetic product with the puff to perform makeup, the compact container of the related art has the entire discharge plate formed of the metal material as shown in FIG. 1, so that a top surface of the metal discharge plate is scratched by fine foundation cosmetic powder, which causes metallic color such as unique dark rust of metal to come out, thereby generating a unique odor of the metal plate.

However, the compact container of the present invention has the discharge plate 60 formed of the transparent synthetic resin material, and the aluminum foil is insert-molded on the bottom surface of the discharge plate 60, so that the compact container of the present invention has an appearance of a metal plate while the metal material is not exposed on the top of the discharge plate. Accordingly, the metal portion of the discharge plate 60 is prevented from being scratched and discolored by the fine grains of the cosmetic product discharged to the top surface of the discharge plate 60, or producing the unique odor of metal.

In addition, the discharge plate 60 of the present invention may give an impression the same as the metal discharge plate while the production cost is reduced to be lower than the compact container of the related art in which the entire discharge plate is formed of the metal.

The opaque thin film 64 may be formed of opaque or translucent cellophane paper having various colors or designs.

In other words, the opaque or translucent cellophane paper is insert-molded onto the bottom surface of the discharge plate 60 formed of the transparent synthetic resin material, so that the color or design of the cellophane paper can be seen faintly through the transparent discharge plate 60, which allows the color or design of the discharge plate 60 to be variously changed.

Various images or logos may be printed on the opaque thin film 64.

In addition, the opaque thin film 64 may be insert-molded such that the opaque thin film 64 surrounds the bottom surface and an outer periphery of the discharge plate 60 formed of the transparent synthetic resin material.

The coupling ring 70 for fixedly coupling the dispersion distribution plate 50 and the discharge plate 60 is provided outside the dispersion distribution plate 50 and the discharge plate 60.

The coupling ring 70 includes a ring-shaped lower coupling ring 72 and a ring-shaped upper coupling ring 74 coupled to an upper portion of the lower coupling ring 72.

A discharge plate seating part 722 in which the discharge plate 60 is seated is formed on the upper portion of the lower coupling ring 72, and a plurality of fastening holes 724 are formed in an outside of the discharge plate seating part 722.

A coupling recess 726 is formed inside the lower coupling ring 72 so as to be coupled to the coupling annular protrusion 55 of the dispersion distribution plate 50.

A discharge plate press part 742 for pressing the discharge plate 60 is formed at a lower inner side of the upper coupling ring 74, and a fastening protrusion 744 coupled to the fastening hole 724 of the lower coupling ring 72 is formed at an outer side of the discharge plate press part 742.

The fixing member 90 is coupled to an inner upper side of the outer container 10.

The fixing member 90 pushes the container body 30 to fix the container body 30 while allowing the coupling ring 70 coupled with the dispersion distribution plate 50 and the discharge plate 60 to move up and down without moving left and right.

In addition, the fixing member 90 also serves to prevent foreign substances from entering into a gap between the outer container 10 and the container body 30.

A coupling groove 92 is formed at an outer periphery of the fixing member 90 so as to be coupled to the coupling protrusion 12 of the outer container 10, and a push protrusion 94 protrudes from an inner periphery of the fixing member 90 so as to fix an upper end of the container body 30 by pressing the upper end of the container body 30.

A method of assembling the compact container, which has the above-described structure, having the opaque thin film insert-molded onto the bottom surface of the transparent discharge plate will be described as follows.

In order to assemble the compact container having the opaque thin film insert-molded onto the bottom surface of the transparent discharge plate according to the present invention, as shown in FIGS. 3 and 4, the container body 30 is seated inside the outer container 10 to which the outer container lid 20 is hinged, and the cosmetic product is filled inside the container body 30.

Next, the discharge device support 80 is coupled to an inner upper side of the container body 30, a push plate 89 is mounted at an inner upper side of the discharge device support 80, and the mounting annular protrusion 882 of the discharge device support 80 is coupled to the mounting groove 32 of the container body 30.

Thereafter, the discharge device 40 is installed in the discharge device installation hole 82 of the discharge device support 80.

Next, the discharge plate 60 is coupled to the top of the dispersion distribution plate 50 by using a sealing ring 59 and the coupling ring 70, the dispersion distribution plate 50 is coupled to a center of the lower coupling ring 72 such that the coupling annular protrusion 55 of the dispersion distribution plate 50 is coupled to the coupling recess 726 of the lower coupling ring 72, the discharge plate 60 is seated in the discharge plate seating part 722 of the lower coupling ring 72, and the upper coupling ring 74 is fixedly coupled to the upper portion of the lower coupling ring 72.

At this time, the discharge plate 60 is formed of the transparent synthetic resin material, and the aluminum foil or the cellophane paper is insert-molded onto the bottom surface of the discharge plate 60.

Next, the coupling ring 70, in which the dispersion distribution plate 50 and the discharge plate 60 are assembled as described above, is coupled to the upper portion of the discharge device 40, such that the upper portion of the piston 42 of the discharge device 40 is coupled to the inner side of the first lower extension annular protrusion 51 of the dispersion distribution plate 50, and the second lower extension annular protrusion 53 is coupled to an upper portion of the sealing member 44 of the discharge device 40.

Finally, the fixing member 90 is coupled to the inner upper side of the outer container 10, such that coupling protrusion 12 of the outer container 10 is coupled to the coupling groove 92 of the fixing member 90 while the push protrusion 94 of the fixing member 90 fixes the upper end of the container body 30 by pressing the upper end of the container body 30. Accordingly, the assembly of the compact container having the opaque thin film insert-molded onto the bottom surface of the transparent discharge plate according to the present invention is completed.

A method of using the compact container, which is assembled by the above-described assembly method, having the opaque thin film insert-molded onto the bottom surface of the transparent discharge plate will be described as follows.

In order to use the compact container having the opaque thin film insert-molded onto the bottom surface of the transparent discharge plate according to the present invention, the button 14 of the outer container 10 is firstly pressed to open the outer container lid 20 from the outer container 10.

Thereafter, when a top surface of the discharge plate 60 is vertically pressed, the dispersion distribution plate 50 and the coupling ring 70 are moved downwards together with the discharge plate 60 while the piston 42 of the discharge device 40 coupled to a lower portion of the dispersion distribution plate 50 also moves downwards.

When the piston 42 is moved downwards, the piston ring 43 fitted around the piston 42 is in close contact with the inner side surface of the discharge device installation hole 82, so that only the piston 42 moves downwards, which generates a gap between the piston 42 and the piston ring 43 to create a discharge passage for the cosmetic product.

When the dispersion distribution plate 50 is continuously pressed, as shown in FIG. 5, the piston ring 43 makes contact with the first and second lower extension annular protrusions 51 and 53 of the dispersion distribution plate 50 and moves downwards together with the piston 42, which causes the volume inside the discharge device installation hole 82 to be reduced. Accordingly, the check valve 41 closes the cosmetic product suction hole 822 by the discharge pressure inside the discharge device installation hole 82, while the cosmetic product accommodated in the discharge device installation hole 82 flows between the piston 42 and the piston ring 43 and passes through the inside of the piston 42.

Thereafter, the cosmetic product passed through the inside of the piston 42 is discharged through the cosmetic product discharge port 52 of the dispersion distribution plate 50 and widely spread in the dispersion space 54 while being discharged through the discharge opening 62 of the discharge plate 60.

When the pressing force applied to the discharge plate 60 is released, the dispersion distribution plate 50 is moved upwards by the elasticity of the elastic member 45 that elastically supports the dispersion distribution plate 50, and the piston 42 coupled to the lower side of the dispersion distribution plate 50 is moved upwards together, while the extension annular protrusion 422 formed at a lower outer side of the piston 42 pulls up the piston ring 43. Accordingly, as the gap between the piston 42 and the piston ring 43 is blocked, the piston 42 and the piston ring 43 move upwards together, which cause the volume inside the discharge device installation hole 82 to increase, so that a vacuum pressure is generated.

Thereafter, as shown in FIG. 6, the check valve 41 opens the cosmetic product suction hole 822 formed in the bottom surface of the discharge device installation hole 82 by the vacuum pressure generated inside the discharge device installation hole 82. Accordingly, the cosmetic product accommodated in the container body 30 is introduced into the discharge device installation hole 82 through the cosmetic product suction hole 822, which causes the push plate 89 to move downwards.

As described above, although the compact container having the opaque thin film insert-molded onto the bottom surface of the transparent discharge plate according to one embodiment of the present invention has been described for illustrative purposes, the present invention is not limited thereto. It is understood that various changes and modifications can be made by those skilled in the art without departing from the spirit and scope of the present invention as disclosed in the accompanying claims.

What is claimed is:

1. A compact container comprising:
an outer container (10);
an outer container lid (20) hinged to one side of the outer container (10) so as to be opened and closed;
a container body (30) mounted inside the outer container (10);
a discharge device (40) for discharging a cosmetic product;
and a discharge plate (60) adjacent to the discharge device (40),
wherein the discharge plate (60) is formed of a transparent synthetic resin material, and an opaque thin film (64) is insert-molded onto a bottom surface of the discharge plate (60).

2. The compact container of claim 1, wherein the discharge device (40) is a pump which includes a check valve (41), a piston (42), a piston ring (43), a sealing member (44), and an elastic member (45).

3. The compact container of claim 1, wherein the discharge plate (60) is formed therein with a plurality of discharge openings (62), and the opaque thin film (64) is formed therein with through holes (642) disposed at a position corresponding to the discharge openings (62).

4. The compact container of claim 1, wherein the opaque thin film (64) is formed of a metal material.

5. The compact container of claim 4, wherein the opaque thin film (64) is an aluminum foil.

6. The compact container of claim 1, wherein the opaque thin film (64) is opaque or translucent cellophane paper having various colors or designs.

7. The compact container of claim 1, wherein various images or logos are printed on the opaque thin film (64).
